(19) United States
(12) Patent Application Publication
(10) Pub. No.: US 2004/0205645 A1
(43) Pub. Date: Oct. 14, 2004

(54) Customized textbook systems and methods

(75) Inventor: Andrew J. Hoffman, Pawtucket, RI (US)

Correspondence Address: FOLEY HOAG, LLP, PATENT GROUP, WORLD TRADE CENTER WEST, 155 SEAPORT BLVD, BOSTON, MA, 02110, US

(73) Assignee: Goosewing, Inc.

(21) Appl. No.: 09/783,194

(22) Filed: Feb. 14, 2001

Related U.S. Application Data
(60) Provisional application No. 60/182,339, filed on Feb. 14, 2000.

(51) Int. Cl. G06F 17/21

(52) U.S. Cl. 715/530

(57) ABSTRACT

The methods and systems that can be implemented on a network such as the internet, wherein a server can access information on a database that includes modularized data files. A single modularized data file can be related to a single topic and can be associated with one or more other modules. A user accessing the server can specify a sequence of modules to generate a customized text. Modules can thereafter be further edited by users for greater customization. Modules can be associated with tags that characterize the modules by subject matter, degree of difficulty, learning scales, or other desired measures. Modules can be presented to a user based on one or more of the tag characteristics.

### CLAIM OF PRIORITY

This application claims priority to U.S.S.No. 60/182339, entitled “Electronic Curriculum Development Product”, filed on Feb. 14, 2000, naming Andrew Hoffman and Theodore Winston as inventor(s), the contents of which are herein incorporated by reference.

### BACKGROUND OF THE INVENTION

(1) Field of the Invention

The present invention relates generally to the generation of individualized textual materials, and more particularly to the creation of curriculum and individualized instructional materials.

(2) Description of the Prior Art

Presently, certain educational technology services have been proposed and some implemented to provide teachers, principals, administrators, and other education professionals with tools for teaching skills and material to students. Some of these tools are software programs that allowing student interaction and hence individualized instruction that can identify and target a student's weakness in understanding a topic or mastering a skill set. Although individualized learning can be helpful to a student needing special attention, a major focus of the teaching experience relates to developing a useful and effective curriculum for the majority of students. Developing an effective curriculum often necessitates selecting a proper textbook.

Selecting textbooks can be a time consuming job that includes studying dozens of different texts that can include massive compendia that encompass a broad a swath of topics. Some textbooks are created through a process that allows material in the textbook to be filtered through textbook adoption committees in states such as California and Texas. These committees often suggest revisions to the textbooks. As publishers can only afford to publish a few textbooks, and the textbooks are intended for sale throughout the entire United States, the approval of the committees of the most populous states can be viewed as a controlling factor. The result is a selection of textbooks that often include much more material than is desired for a selected curriculum. Educators can be therefore be forced to create a book from within a book by selecting certain chapters and pages to review from the book, and by offering supplements for the book's deficiencies.

There is currently not a cost-efficient method or system of providing individualized yet organized information on topics, such as educational subjects.

What is needed is a cost-efficient method and system for providing organized information on an individualized basis.

### SUMMARY OF THE INVENTION

The methods and systems herein include a server that can access at least one database. The database can include what can be referred to herein as modules, wherein a module can be any grouping of textual and/or graphical information related to a subject. The depth of information about a subject within a module can be variable, and therefore a single subject matter can correspond to multiple modules that have differing depths of information. In an embodiment, the modules can be associated with one or more tags, wherein a tag can be understood herein to be any data such as a descriptor associated with a module. Tags can indicate, for example, the depth of information included in the associated module. Tags can also be used to associate modules. For example, tags can associate modules within the same subject matter. Tags can also associate modules with the same degree of informative depth. In an educational example, tags can associate modules specific to a particular grade level and/or achievement level.

The methods and systems also include at least one client that can access the server, wherein in an embodiment, the clients can access the server via a network such as the internet. A user at a client can provide to the server certain information that allows the server to extract information from the at least one database. The server can present modules to the client and/or user, wherein the modules can be selected for presentation using criteria provided by the client and/or user. For example, a user can voluntarily or involuntarily provide a profile to the server whereupon the server can access a previously generated or newly generated criteria for selecting and presenting modules to the user. Using a graphical user interface (GUI), the user can change the presentation of selected modules, and can optionally and additionally select particular modules. In an embodiment, users can view the tags associated with modules. In one embodiment, modules can be designated in a series according to one or more tags, or alternately and optionally, modules can be designated individually. Modules designated by a user can be provided in a textbook format to a user to allow the user to edit the textual and graphical items in the textbook. A user can save an edited textbook for future editing sessions. Textbooks can also be printed on a server-local printer and in some embodiments, delivered to the user via any one of well-known mail and/or delivery techniques. Alternately and optionally, textbooks can be transferred to a client for printing at a location to be specified by the client.

In one embodiment, textbooks generated by users can be categorized and presented to other users for selection and optional editing.

In an educational embodiment, the systems and methods described herein can allow a parent, an educator, or student to create a textbook that includes text and graphics, that presents information or other material related to a certain topic according to a learning process or interests selected by that individual. In this embodiment, the systems and methods include an internet site or Uniform Resource Location (URL) that allows an individual to provide parameters representative of the curriculum, preferences, and other selected guidelines, wherein the parameters can be employed by the site to search for and select content that can be assembled into a textbook according to the teaching plan or learning plan of that individual. These preferences can include the topic of the material, the standard adopted by the school, themes to be emphasized, and other similar preferences.

In an embodiment, a customized textbook can be associated with a virtual classroom that can include textual information in the form of notes that can be created by a parent or educator. Additionally, the virtual classroom can include notes that can further include or be presented with references that can be accessed via HTTP links to URLs, for example. Exam questions or other assignments can also be presented. Exam questions can be answered wherein the answered exam can be submitted and thereafter retrieved by an educator or parent, or alternately emailed to the parent or educator.

### BRIEF DESCRIPTION OF THE DRAWINGS

A more complete understanding of the invention and many of the attendant advantages thereto will be readily appreciated as the same becomes better understood by reference to the following detailed description when considered in conjunction with the accompanying drawings, wherein like reference numerals refer to like parts and wherein:

FIG. 1 represents a system for designing a textbook according to the systems and methods disclosed herein.

FIG. 2 relates to a method for designing a textbook according to the systems and methods disclosed herein.

FIG. 3 illustrates a second method for preparing a textbook according to the systems and methods disclosed herein.

FIGS. 4 through 16 depict user interfaces from a web site constructed according to implement methods and systems according to the principles of the invention as discussed relative to FIG. 1-3.

### DESCRIPTION OF ILLUSTRATED EMBODIMENTS

To provide an overall understanding of the invention, certain illustrative embodiments will now be described; however, it will be understood by one of ordinary skill in the art that the systems and methods described herein can be adapted and modified to provide systems and methods for other suitable applications and that other additions and modifications can be made to the invention without departing from the scope hereof.

The systems and methods disclosed herein can be related to any retrieval of one or more related modules, wherein a module is a grouping of text and/or graphical information related to a given subject. For example, the illustrated systems and methods include examples wherein text can be retrieved for use in textbooks, wherein an educator or other can selectively retrieve information or modules in organized segments such as lesson plans, for incorporation into the textbook. The methods and systems can also be applied to other applications. For example, a traveler going to a particular destination can download modules related to the destination that can include hotels, sights, restaurants, etc., and hence create a textbook related to the destination.

For discussion purposes, with relation to the illustrated embodiments, the systems and methods described herein permit a user to assemble a customized textbook from a selection of prepared subunits or modules based on the specifications that can include subject matter, difficulty level, and curriculum requirements, although those with ordinary skill in the art will recognize that such specifications are provided merely for illustration and not limitation. For example, an educator can design a textbook by selectively including desired information or modules, excluding unwanted or unnecessary information or modules, hence providing a textbook that is catered in complexity, depth, approach, etc., to a specific or particular course or topic. By including only desired information in the textbook, the educator can obtain sufficient copies of a suitable textbook at a price lower than required for a standard, over-inclusive textbook. Alternately, an educator can obtain an assortment of specialized materials directed to a range of topics. As indicated previously, the invention herein is not limited education textbooks and textbook, as the term in used herein, and can include any textual and/or graphical document or publication that can be generated using one or more modules as defined herein. In an embodiment wherein a textbook is an educational resource, a textbook can be any publication suitable for instructional purposes for any course or instructional unit, such as a full-year course, a semester-long course, a unit or topic in a course, a seminar, etc. In some embodiments, a textbook can be substantially devoted to a particular topic or theme, including, as indicated earlier, restaurants, sites, or hotels in a particular area, or in the education application, American history, English literature, biology, calculus, etc., such as can be taught in an elementary, middle school, high school, or college course or seminar.

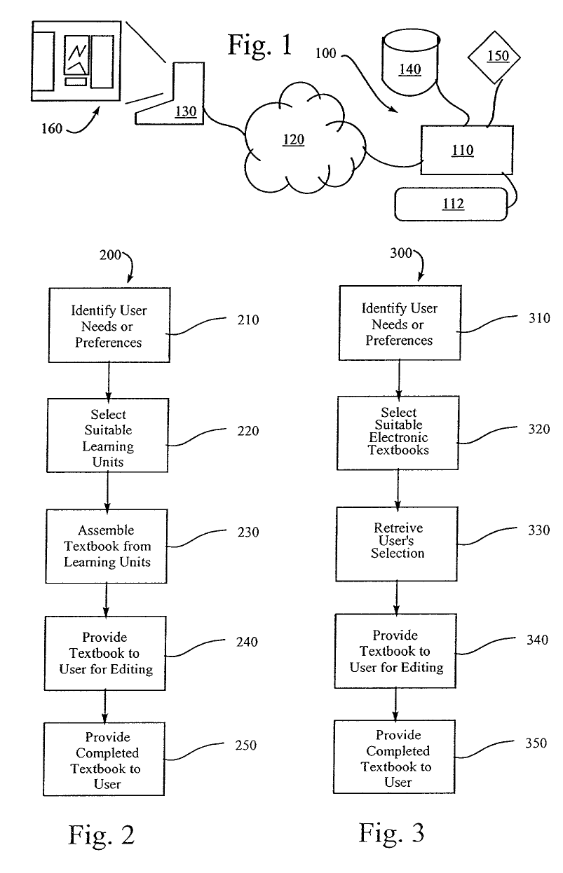

FIG. 1 provides a block diagram 100 representative of a system and method according to the invention, however, those with ordinary skill in the art will recognize that the such an illustration is intended merely for illustrative purposes, and the other embodiments of the systems and methods can be practiced which combine illustrated components, include components not otherwise illustrated, or both. The FIG. 1 illustrative system 100 includes a server 110. An exemplary server 110 includes a processor, a memory (e.g. RAM), a bus which couples the processor and the memory, a mass storage device (e.g. a magnetic or optical disk) coupled to the processor and the memory through an I/O controller, and a network interface coupled to the processor and the memory. Servers can be clustered together, and can include separate servers for different functions such as a database server, an application server, and a Web presentation server. Such servers can further include one or more mass storage devices such as a disk farm or a redundant array of independent disk (“RAID”) system for additional storage and data integrity. Read-only devices, such as compact disk drives and digital versatile disk drives, can also be connected to the servers. Suitable servers and mass storage devices are manufactured by, for example, Compaq, IBM, and Sun Microsystems. As used herein, the term “server” is intended to refer to any of the above-described servers 110.

The FIG. 1 Server 110 can be connected to a data processing platform 112 for processing information and commands received by one or more clients 130 and can additionally access at least one database 140. Server 110 can be accessed over a network 120, such as the Internet, by the one or more clients 130. System 100 can further include a printer 150 for printing paper versions of electronic materials, wherein the printer 150 can be accessed either locally or through a network connection. The system 100 of FIG. 1 can utilize a network such as the Internet to allow a remote client 130 to access the server 110, to login to an account maintained by that server 110, and to employ the services provided to that account to design a customized textbook. For example, the server 110 can present the subscriber with an HTML page that acts as a user interface, although those with ordinary skill in the art will recognize that there are many different ways to generate a user interface, including a graphical user interface (GUI), and the invention herein is not limited by such technique. This user interface can present to the subscriber a set of options and/or controls for designing a textbook by providing to the system 100 information representative of the user's guidelines and preferences. For example, the user interface can provide to the subscriber a control, such as a radio button, input text box, check box, slider, etc., on a web page, that provides relevant information to the system.

Client 130, or additionally and optionally, server 110, can be any suitable computer system such as a PC workstation, a handheld computing device, a wireless communication device, telephone, or any other such microprocessor-controlled device, equipped with a network connection for accessing a network server. For the purposes of the discussion herein, server 110 and client 130 can be similar devices.

In one embodiment, the client 130 can be a web client, such as a web browser that can include the Netscape web browser, the Microsoft Internet explorer web browser, the Lynx web browser, or a proprietary web browser, or web client that allows the user to exchange data with a web server, an ftp server, a gopher server, or some other type of network server. Optionally, the client 130 and the server 110 can rely on an unsecured communication path, such as the Internet, for accessing services on the remote server. To add security to such a communication path, the client and the server can employ a security system, such as any of the conventional security systems that provide to the remote user a secured channel for transmitting data over the a network such as the internet, for example. One such system is the Netscape secured socket layer (SSL) security mechanism that provides to a remote user a trusted path between a conventional web browser program and a web server. Optionally and additionally, the client 130 and the server 110 can include 128-bit or 40-bit SSL capability and can establish an SSL communication channel between the clients 130 and the server 110. Other security systems can be employed, such as those described in Bruce Schneir, Applied Crytpography (Addison-Wesley 1996). Alternatively, the systems can employ, at least in part, secure communication paths for transferring information between the server 110 and the client 130. For purpose of discussion with respect to FIG. 1, the illustrated system 100 can be understood to employ a public channel, such as an Internet connection through an ISP or any suitable connection, to connect the subscribers or clients 130 and the server 110.

The data processing platform 112 depicted in FIG. 1 can be any suitable data processing platform including a conventional IBM PC workstation operating the Windows operating system, or a SUN workstation operating a version of the Unix operating system, or any other suitable workstation.

In the embodiment of FIG. 1, the server 110 can include a web server, such as the Apache web server or any suitable web server. The web server component of the server 110 can respond to a request from any one or more of the clients 130, resolve the request to identify a filename, script, and/or dynamically generated data that can be associated with that request, and return the identified data to the requesting client 130. The operation of the web server component of server 110 can be understood more fully from Laurie et al., Apache The Definitive Guide, O'Reilly Press (1997).

The server 110 can couple to a database 140 that stores information representative of a subscriber's account, including information about the different financial service providers that the subscriber employs and information regarding the subscribers accounts, including passwords, user accounts, user privileges, and any other information that can be applicable to an embodiment as practiced according to the methods and systems herein. The depicted database 140 can include any suitable database system, including the commercially available Microsoft Access database, Oracle, Sybase, MYSQL, and Informix, etc., and can be a local or distributed database system. Those with ordinary skill in the art will recognize that the databases presented herein are merely illustrative and not intended for limitation, and the database 140 can include, for example, a database server. The design and development of the database 140 suitable for use with the system 100 can follow from principles known in the art, including those described in McGovern et al., A Guide To Sybase and SQL Server, Addison-Wesley (1993). The database 140 can be supported by any suitable persistent data memory, such as a hard disk drive, RAID system, tape drive system, floppy diskette, or any other suitable system. The system 100 depicted in FIG. 1 includes a database 140 that is separate from the server 110, however, it will be understood by those of ordinary skill in the art that in other embodiments the database 140 can be integrated with the server 110.

In one embodiment, the system 100 can include a graphical interface 160 representative of what one of ordinary skill in the art would understand to be a web page or web site that can include at least one page of data accessible to a client 130 using a web browser as described above. The interface 160 can collect information from the user that can serve as content guidelines for selecting modules and/or textbook content. This systems and methods can utilize the collected information, for example, to correlate known preferences or other information with the user to provide the user with individualized options and selections, and/or modules related to such options and selections. For example, if a user is interested in developing a curriculum for a particular educational course and it is known that the user must satisfy certain state-mandated requirements in providing such curriculum, the system 100 can provide to such user a choice of curriculum that can emphasize the state-mandated requirements. Continuing with the educational example, information or selections for a particular user can be provided based on the user's known preferences regarding teaching style. Those with ordinary skill in the art will recognize that the list of preferences by which information can be filtered and thereafter presented to the user is without limit and is not a limitation of the methods and systems herein. The system 100 can receive the data representative of the user's particularized needs and preferences, can store the data using any suitable storage medium such as a database, and retrieve information from the database that pertains to a user, when a user is recognized. Users can be recognized using any one of many well-known techniques, including log-in information, account information, user passwords, cookies, etc.

In a method 200 depicted in FIG. 2, the system 100 can query a user to determine the particularized needs of the user 210. For example, the system can provide to the user a form, a series of questions, or a selection of options over an interface such as a web browser to identify relevant information from the user. In the educational context, such information can include the subject matter of the course in question, the age level of the students, an appropriate difficulty level, a desired text length, the number of classes in the course, a desired workload per class, desired proportions of text and graphical material, such as illustrations, graphs, maps, etc., the user's teaching and/or learning style, the format of the course, the aspect emphasis of the course (e.g., political, economic, or social, for a history course), desired assignment types, the user's location, information representative of the user's budget, e.g., a desired cost per copy, or total cost, or any other information useful for selecting appropriate materials for inclusion in a textbook. In other embodiments wherein modules can be linked to generate a textbook for non-educational purposes such as a travel book, questions or information to be retrieved from the user can include budget, time of travel, dates of travel, etc. Returning to the educational example, the system 100 can determine the grade or difficulty level, the workload per class, the number of classes, the aspect emphasis, the assignment types, and the illustration types (e.g., photographs, charts and graphs, diagrams, cartoons, etc.) preferred or desired by the user. Using this information as a content guideline, the system 100 can then search the database 140 to identify learning units that suit the user's criteria or needs 220.

For the educational textbook embodiment, several techniques can be employed for creating a gradated spectrum of textbooks based on the user's criteria. For example, the database 140 can include a variety of learning units with fine gradations for difficulty level, so that for different user preferences, the system 100 can select learning units having a corresponding difficulty level. Alternatively, the database 140 can include learning units directed at a limited number of difficulty levels, and the system 100 can vary the difficulty level of a textbook by varying the proportion of more and less difficult learning units selected. Using this method, textbooks can be created having more finely gradated difficulty levels than the limited number of discrete difficulty levels of the learning units taken individually.

The database 140 can include textbook subunits, also referred to herein as learning units, which can cover a broad array of difficulty levels, subjects, approaches, styles, etc., including textual and non-textual materials, and learning units which include both textual and non-textual materials. Learning units can also be understood to be one or more associated modules. For example, the database 140 can include individual illustrations, e.g., with or without captions, sections of text, assignments, projects, etc., and/or entire chapters covering a subject, including appropriate graphical materials, sidebars, assignments, and other features. In certain embodiments, for any general topic or subtopic, the database 140 can include learning units that present the same theme or core information, but differ with respect to difficulty level, aspect emphasis, length, detail, etc., thereby providing a library of learning units suitable for a wide range of user preferences. The database can also store tags or other indicia that identify key characteristics of the learning units, including difficulty level, subject matter, keywords, approach, style, or any other criteria desired to be matched with the educator.

In an embodiment, the modules can be associated with one or more tags, wherein a tag can be understood herein to be any data such as a descriptor associated with a module. Tags can indicate, for example, the depth of information included in the associated module. Tags can also be used to associate modules. For example, tags can associate modules within the same subject matter. Tags can also associate modules with the same degree of informative depth. In an educational example, tags can associate modules specific to a particular grade level and/or achievement level.

Because some states, localities, or regions have predetermined and/or required curricula, the database 140 can also include curriculum guidelines for different locations. Accordingly, after identifying an educator's location, the system 100 can consult the curriculum guidelines to select appropriate materials. For example, the curriculum guidelines can include a chart or other association correlating a particular location, subject, and grade level with topics required for inclusion in the course. Alternatively, tags associated with learning units can indicate that the subject matter of that learning unit is required for a particular location, course, and grade level, and the system 100 can identify tags matching the user's preferences for location, subject matter, and grade level or difficulty. Any other technique for identifying prescribed course materials for a curriculum can be employed without departing from the scope of the systems and methods disclosed herein. Additionally, a user can be able to choose from a set of optional topics that can be selected in addition to required material.

The system 100 can compile or assemble identified learning units into a textbook 230. Selected learning units can be assembled into a textbook by any of a variety of techniques. For example, the tags can include information indicative of an order, for example, chronological for historical learning units, or complexity for mathematical learning units, in which the learning units can be arranged. Tags for non-textual learning units can include information suitable for pairing a non-textual learning unit with a textual learning unit relating to similar subject matter. Alternatively, the user can determine an order for learning units by, for example, ranking or manipulating the learning units, wherein such ranking or manipulation can be performed using a system-generated electronic mock-up of the textbook. This strategy can be useful, for example, in a world cultures course where the ordering of substantially independent African, Asian, European, Pacific, and South American learning units can be subjective. A combination of these strategies can also be employed by combining learning units into cohesive topics or chapters and permitting the user to order these portions. For example, a biology textbook might include substantially independent chapters on taxonomy, cells, genetics, and ecosystems which can be sequenced by the user, although the learning units or modules in a given chapter can follow a predetermined sequence despite including optional subunits.

In compiling or assembling the learning units or modules, the system 100 can form one data files that can include the learning units, more than one data files that can include units or chapters of a complete textbook, and/or instructions for assembling a textbook from learning units, optionally including, for example, information indicative of the order of the learning units, of a desired layout, etc.

The selected and ordered modules or learning units can then be presented to the user in an editorial interface 240 that can be an electronic version of the textbook that can be edited by the user and hence printed. The user can thus add, remove, or alter portions of text, replace graphical elements with other graphical elements, adjust the layout of the material, or vary one of the initial parameters or content guidelines, such as difficulty level or approach, to provide an increasingly customized textbook. The interface can, alternatively or additionally, present the user with a selection of learning unit options wherein the user can exchange a system-selected learning unit for another similar unit in the database 140, or can add a learning unit to the textbook to supplement the system-selected learning units.

The FIG. 1 system 100 can store the user's edited work on the database 140 to enable the user to perform edit gradually over time. The system can provide a final version o f the created textbook 250 as an electronic document or as one or more printed copies of the created textbook. The system 100 can be configured to include a printer 150 for preparing hard copies of the user's electronic textbook, or for transferring an electronic version of the textbook over a network such as the Internet, or by a computer-readable storage medium, such as a disk, CD, magnetic tape, or other suitable medium, to a printing apparatus capable of printing the user-designed materials in a form suitable for typesetting, binding, or any other printing or distribution procedure. Any type of printing apparatus, including ink-jet printers, printing presses, laser printers, etc., can be employed without departing from the spirit and scope of the systems and methods described herein. The textbook can therefore be stored electronically in and printed from one of many formats, including for example, HTTP, PDF, or other well-known formats.

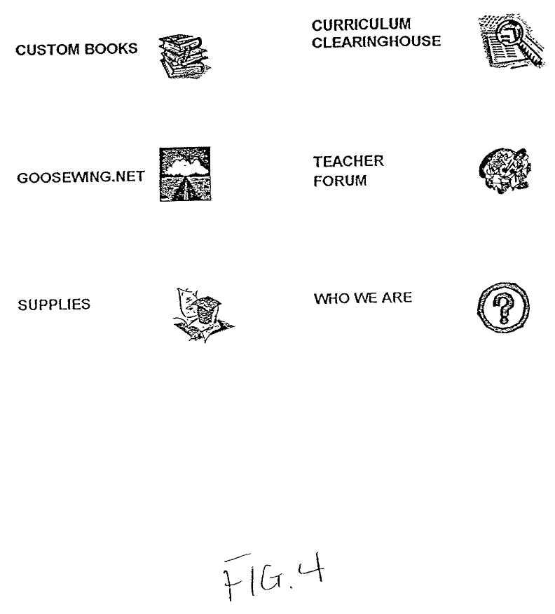

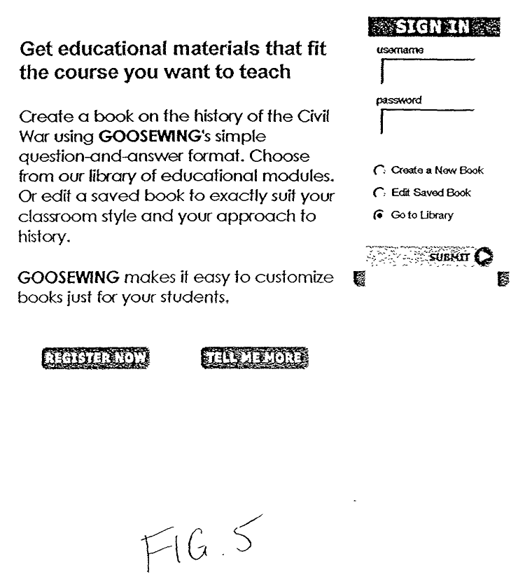

In a second method 300 that can be represented graphically by FIG. 3, the database 140 can include other, previously designed electronic textbooks from which a user can select. Such selections can be recommended by the system 100. These recommended or otherwise prepared selections can be listed with or sorted by a descriptive tag that includes information representative of the user preferences, such as grade or difficulty level, aspect emphasis, length, etc., reflected in the textbook. Additionally or optionally, the system 100 can calculate the preferences to which a textbook would conform by examining the tag or other characteristics of the learning units in the textbook and comparing this information with a set of guidelines or standards, such as guidelines employed by system 100 for creating a textbook from a user's preferences, as described herein. For example, a high school algebra teacher from Michigan who prefers a problem-solving approach to a theoretical approach can select or be presented with electronic textbooks exhibiting a problem-solving approach created by other high school algebra teachers from Michigan, rather than create a textbook from learning units as described herein.

After selecting a textbook 330, the user can alter the textbook content using an editorial interface 340 to personalize the content, approach, layout, or other variables according to the user's preferences. For the illustrated systems, the edited textbook can be stored on the database 140 for access by other users, provided to the user (or subsequent users) 350, etc., as described herein for a textbook created from learning units.

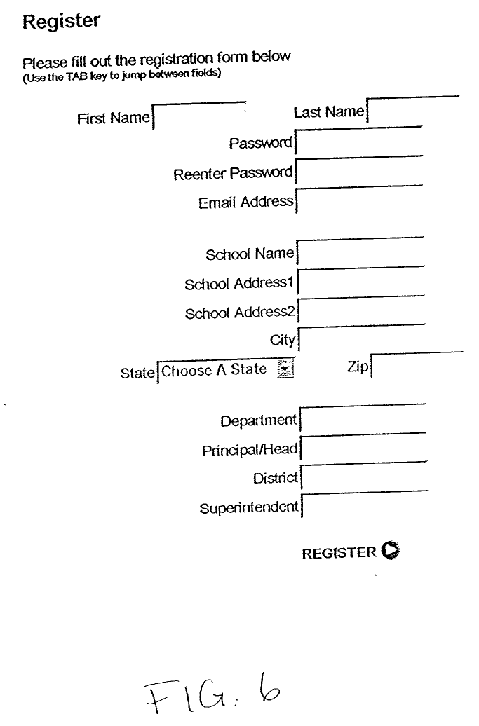

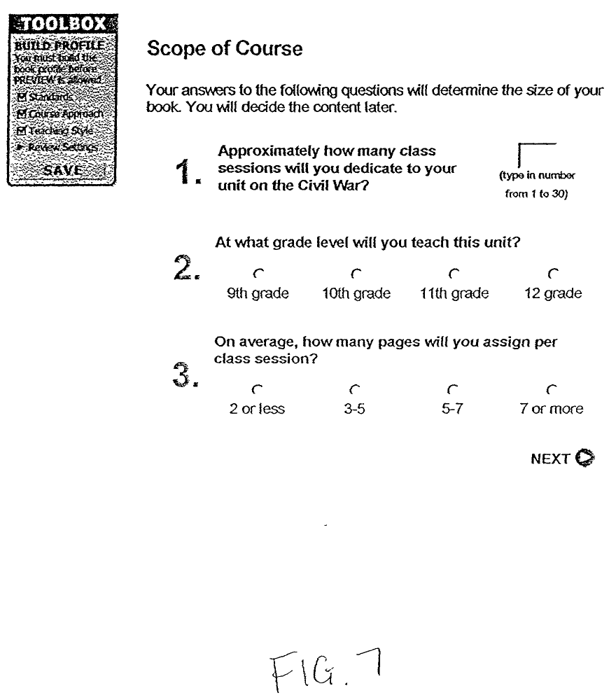

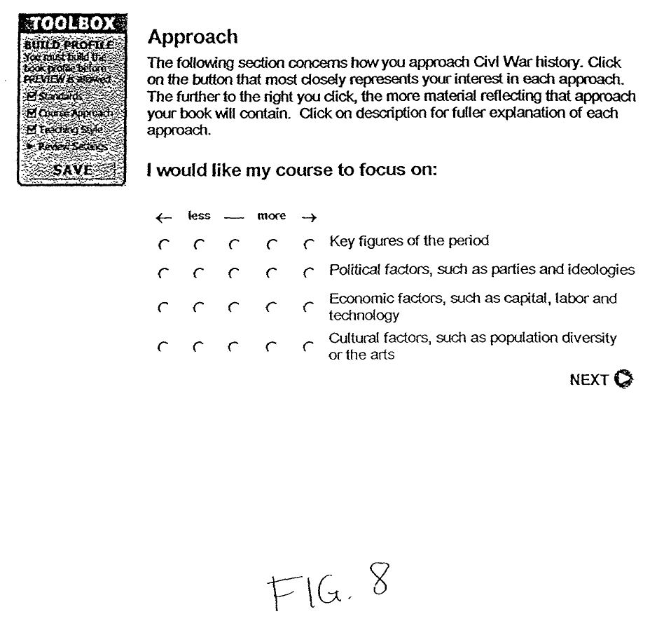

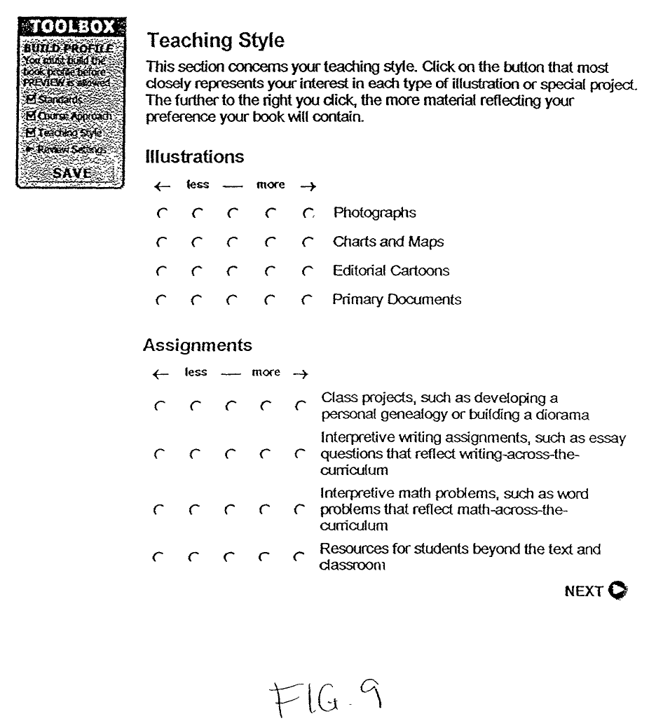

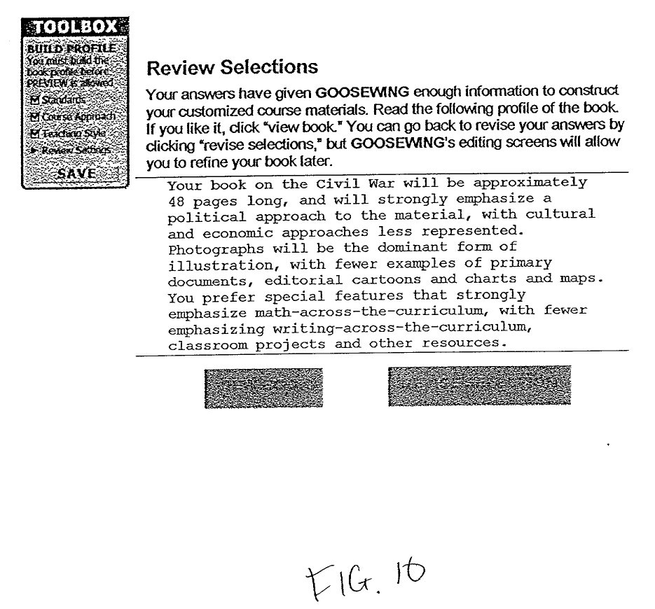

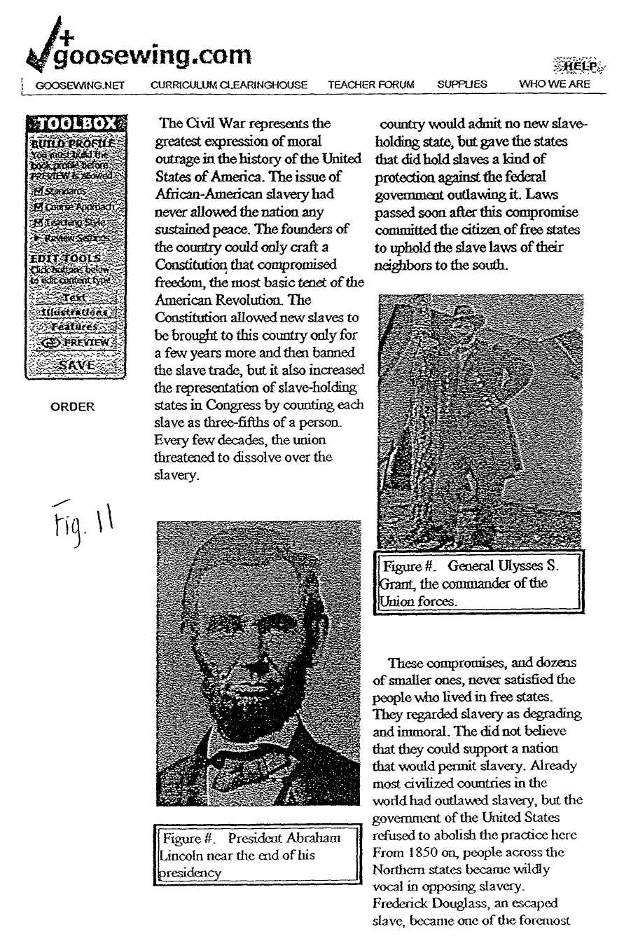

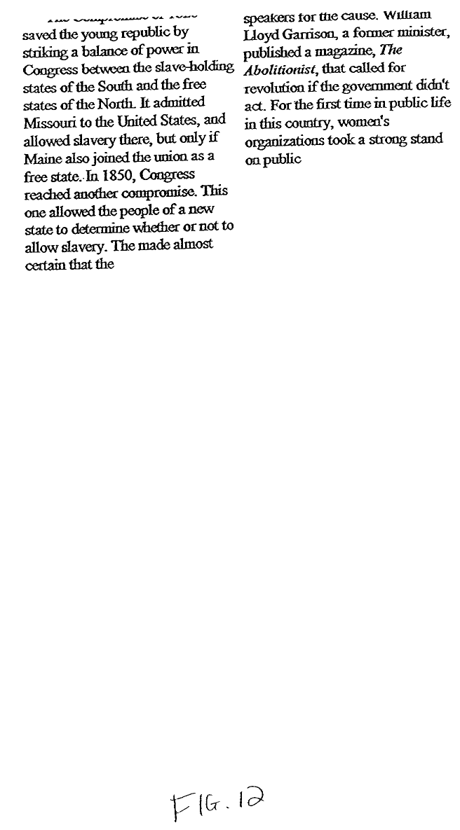

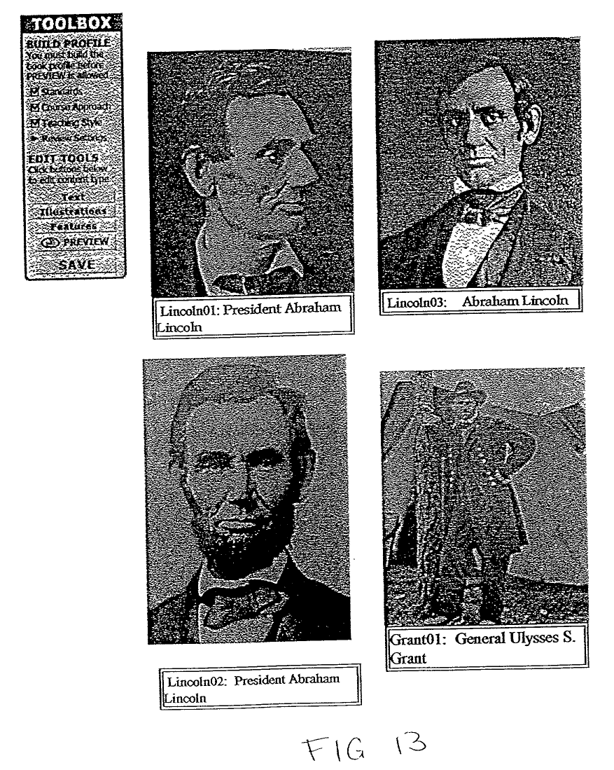

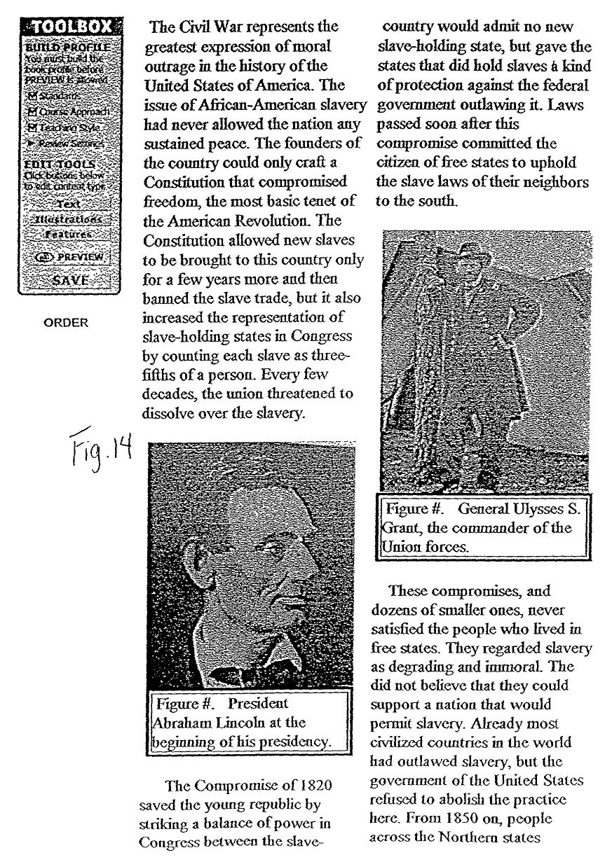

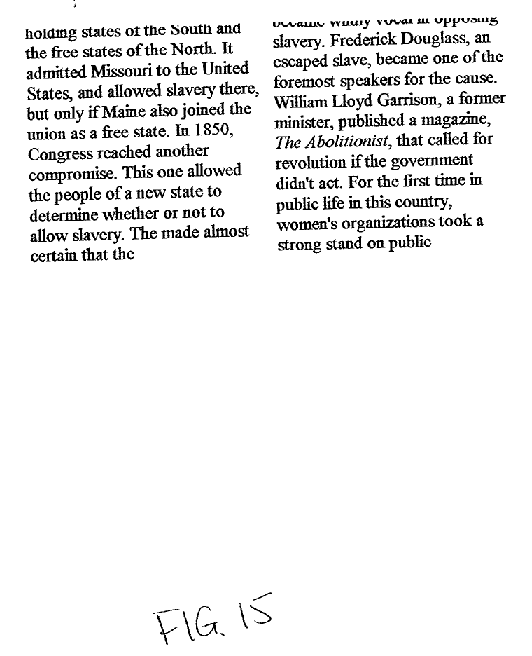

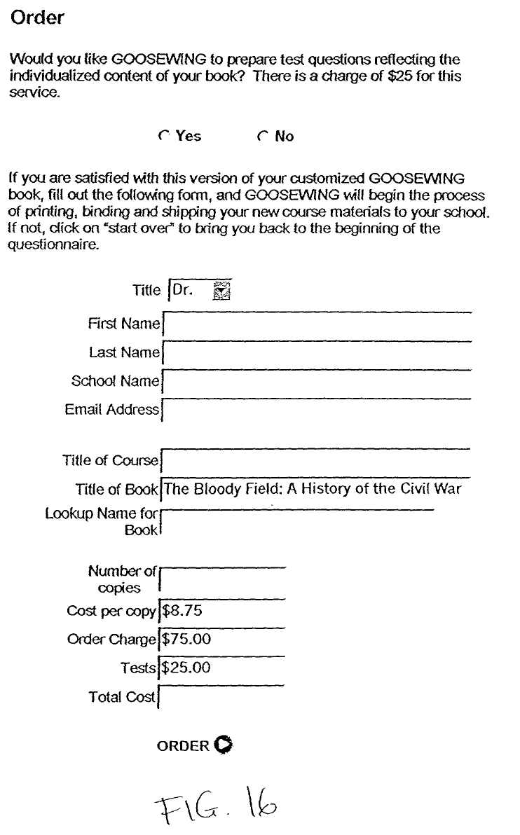

Examples of web pages suitable for carrying out methods 200 and/or 300 are presented as FIGS. 4-15. FIG. 4 presents an initial page useful as a starting point for navigating a web site useful for the systems and methods described herein. FIG. 5 relates to a sign-in page which permits a user to register or log in. FIG. 6 depicts an exemplary page useful for registering a new user and collecting information from a user. FIGS. 7-9 demonstrate exemplary interfaces for prompting a user to provide information representative of the user's preferences, whereby learning units which conform to those preferences can be selected. FIG. 10 presents a sample system response which summarizes the user's preferences and the characteristics of the resulting textbook. FIGS. 11-12 present an exemplary editorial interface, whereby a user can modify the system-created or stored textbook to further customize the materials. FIG. 13 illustrates an exemplary editorial interface, whereby a user can replace a learning unit, such as a photograph, in the system-created or stored textbook with another learning unit, such as a different photograph, from the database. FIGS. 14-15 shows the altered textbook, edited by the user. FIG. 16 depicts a sample order form for ordering one or more copies of a textbook created as described above.

To perform the above functions, the processor 112 can execute a computer program of the type capable of configuring the platform to act as a system according to the invention. In one embodiment, the systems described herein are realized as software components operating on a conventional data processing system, such as the processor 112. Such systems can be implemented as a computer program written in any high level language including C, C++, Fortran, Java, or BASIC, or alternatively and optionally, in machine code. Those with ordinary skill in the art will recognize that the invention is not limited to A method according to implementation. The development of such systems is known to those of skill in the art, and follow from techniques well known in the art for high level programming, including those set forth in, for example, Stephen G. Kochan, Programming in C, Hayden Publishing (1983).

Although the preceding embodiments contemplate a system wherein the processor, database, and associated components are located remote from the user and are accessible over a network such as the Internet using, for example, a web browser, other configurations of the above components are possible within the scope and spirit of the present disclosure. For example, the database and associated query, selection, and editing software can be stored on a computer-readable storage medium, accessed and executed by the user's processor, such as a computer system. A suitable configuration of components for this embodiment is depicted in FIG. 16, wherein the user's processor 112 is connected to a display 150, a database 140, and a server 110, by which the system 100 can access a network 120, such as the Internet. Depending on the storage capacity of the storage medium, the database can be limited to a certain field, such as history or science, a particular course, such as American history or biology, a particular grade level, such as 10^{th} grade, or by any other suitable limitation. Additionally or alternatively, more memory-intensive items, such as graphical learning units, can be stored as versions that require less storage space, e.g., by sacrificing image quality or size. After the textbook assembly and editing phases, as described above, data representative of the customized textbook can be transmitted over a network such as the Internet, or by recording on a computer-readable storage medium, to a system with a database 140 that includes learning units for order and printing purposes. High-quality versions of graphical elements, texts using publishing-quality fonts, etc. can be retrieved from the database 140, even though the user-sited database can include materials of lesser quality. Corresponding items, such as the graphical elements, can be identified on the basis of identification numbers or other statistics of the tag associated with such learning units. The user-edited text, where the text has been altered from the version in the database 140, can be transmitted in its entirety, as text is generally less data-intensive than graphical learning units, or can be represented by a code indicative of the learning unit stored on the database as well as additional data indicative of the changes made during the user's editing process. In this way, the textbook customization procedures and methods described herein can be performed with a minimal reliance on the connection with a network such as the Internet, thus providing faster response times during the selection and editing process, especially for users with low-speed network connections.

In addition to creating a textbook as described above, a user can employ the above system to create an exam based on an individualized textbook. An exam can be created by any number of techniques. For example, for A system according to FIG. 1, the database 140 can store exam questions that relate to the subject matter of corresponding learning units. Accordingly, on the basis of the selected learning units, the system 100 can retrieve exam questions appropriate to the content of the assembled textbook. Alternatively, system 100 can include a question generator or language processor which can analyze prose and create questions based on sentences in the text of the textbook. Other techniques will be readily envisioned by those of skill in the art, and such techniques or combinations thereof can be employed to generate exam materials suitable for a customized textbook by a method described above.

In an embodiment, the methods and systems herein can provide a virtual classroom that can include the customized textbook. For example, the virtual classroom can be accessed using an account and/or password that can be established using the methods and systems herein, and the account and/or password can be thereafter distributed by the educator or parent to the student(s). Access to the virtual classroom can provide access to the customized textbook, instructions or notes from the educator, links to URLs or other websites that include information pertinent to the textbook or an aspect of the assignment, and exam questions associated with the textbook. In one embodiment, a user can present an identity and answer the exam questions. The answered exam can be submitted and thereafter retrieved by an educator or parent, or alternately emailed to the parent or educator. In another embodiment, the answered exam can be stored in a database such as the database 140 of FIG. 1. An educator can design a customized virtual classroom for a particular subject matter, wherein the virtual classroom can include the customized textbook and associated notes, URLs, and exams for a given subject matter, for example.

The virtual classroom concept can also be expanded to non-educational embodiments. For the purposes of the discussion herein, virtual classroom can be understood to be a customized textbook that can be associated with other resources including URLs, HTTP links, image files, textual files, and any other electronic resource. The electronic resources can be accessed locally, such as an image file, or via a network such as the internet, such as a URL. The electronic resources can be associated with the different modules such that when the modules are incorporated into the customized textbook, the electronic resources can be automatically incorporated into the virtual classroom environment. In a non-educational embodiment such as a customized travel book, for example, the customized textbook can include hotels, restaurants, sights, etc., while the associated resources can include URL links to the hotels, images of the sights, listings of restaurant menus or critical reviews of restaurants in the customized textbook, etc.

The following example illustrates a particular embodiment of the systems and methods described herein without limiting the scope of the invention. Those of skill in the art will recognize a wide array of variations and modifications which are intended to be encompassed by the disclosed methods and systems.

In an exemplary system performing an exemplary method as described generally above for the preparation of a high-school history textbook, the system can first provide an interface to a user comprising, for example, a plurality of sliders, whereby the user can input preferences as to the importance of a number of factors which can be used to select learning units according to the user's preferences. For example, a user can indicate the relative importance of politics, economics, and culture to establish a preferred point of view on a historical time period, can indicate the relative importance of primary references, biographical sidebars, and illustrations to establish the types of material to be included, can indicate a grade level to establish a preferred difficulty level, or can indicate the length of the course and the daily workload to establish a preferred textbook length. The input values can be used to determine relative importance among the factors in order to balance the selection of modules or learning units to match the user's preferences. Thus, the system can perform the following steps (field names in Italics are part of tables accessible to the user for providing input):

a) Receive input of user preferences

i) GradeLevel=Input grade level

ii) ClassDays=Input course length in days

iii) HomePages=Input homework pages per night

iv) PrefBio=Input preference (1-100) of “Key Figures and events” question

v) PrefPrim=Input preference (1-100) of “Primary documents” question

vi) PrefPolit=Input view preference (1-100) of “Political Factors” question

vii) PrefEcon=Input view preference (1-100) of “Economic Factors” question

viii) PrefCult=Input view preference (1-100) of “Cultural Factors” question

ix) PrefPhoto=Input preference (1-100) of Illustrations-Photo question

x) PrefMap=Input preference (1-100) of Illustrations-Map question

xi) PrefChart=Input preference (1-100) of Illustrations-Chart question

xii) PrefCartoon=Input preference (1-100) of Illustrations-Political cartoon question

The system can then use these values to determine the relative importance of various selections and the proportions of various types of learning units to be included in order to match the user's input:

b) Determine number of Biographies, Primary documents

NumBio=15*PrefBio/100 (rounded to 0 decimals) (1)

NumPrim=15*PrefBio/100 (rounded to 0 decimals) (2)

c) Calculate View Target Percentages (Polit %, Econ %, Cult %)

TotPref=(PrefPolit+PrefEcon+PrefCult) (1)

Polit %=PrefPolit/TotPref (2)

Econ %=PrefEcon/TotPref (3)

Cult % PrefCult/TotPref (4)

The system can then determine the number of pages based on the length of the course and the amount of homework assigned. Thus, after deducting the number of biographies that will be selected (at one page each) the system can determine the number of 2-page and 4-page units required. Then, using a factor that weights 4-page units 20% (120 vs. 100) more than 2-page units, the user's view preferences can be allocated to each unit. Finally, after a target for each view/length is determined, the units can be randomly assigned up to those targets.

d) Determine number of 4-page (Num4Unit) and 2-page (Num2Unit) units

NumPage=ClassDays*HomePages i)

NumTxtPage=NumPage−NumBio ii)

Num4Unit=(NumTxtPage−30)/2 (rounded to 0 decimals) iii)

Num2Unit=15−Num4Unit iv)

e) Calculate value goal (TotValue)

TotValue=(Num4Unit*120)+(Num2Unit*100) i)

f) Calculate View Value Targets (ValPolit, ValEcon, ValCult)

ValPolit=TotValue*Polit % i)

ValEcon=TotValue*Econ % ii)

ValCult=TotValue*Cult % iii)

g) Find number of 4-page units for each view

i) Determine Political 4-page units

PolitUnRd4Unit=Num4Unit*Polit % (1)

Polit4Unit=PolitUnRd4Unit (rounded to 0 decimals) (2)

Polit4Diff=PolitUnRd4Unit−Polit4Unit (3)

ii) Determine Economic 4-page units

EconUnRd4Unit=Num4Unit*Econ % (1)

Econ4Unit=EconUnRd4Unit (rounded to 0 decimals) (2)

Econ4Diff=EconUnRd4Unit−Econ4Unit (3)

iii) Determine Cultural 4-page units

CultUnRdUnit=Num4Unit*Cult % (1)

Cult4Unit=CultUnRd4Unit (rounded to 0 decimals) (2)

Cult4Diff=CultUnRd4Unit−Cult4Unit (3)

iv) Determine current selected 4-page units

Tot4Unit=Polit4Unit+Econ4Unit+Cult4Unit (1)

v) If Tot4Unit>Num4Unit

(1) Subtract 1 unit from view with lowest value difference

(2) If tie, use lowest view preference

(3) If new Tot4Unit still>Num4Unit

(a) Subtract 1 unit from next lowest value difference

Polit4Unit=Polit4Unit−1 (i)

OR, Econ4Unit=Econ4Unit−1 (ii)

OR, Cult4Unit=Cult4Unit−1 (iii)

(4) Repeat third time if necessary

vi) if Tot4Unit<Num4Unit

(1) Add 1 unit from view with highest value difference

(2) If tie, use highest view preference

(3) If new Tot4Unit<Num4Unit

(a) Add 1 unit from next lowest value difference

Polit4Unit=Polit4Unit+1 (i)

OR, Econ4Unit=Econ4Unit+1 (ii)

OR, Cult4Unit=Cult4Unit+1 (iii)

(4) Repeat third time if necessary

vii) Set “actual” fields to targets to track changes in “edit” mode

ActPolit4Unit=Polit4Unit (1)

ActEcon4Unit−Econ4Unit (2)

ActCult4Unit=Cult4Unit (3)

h) Determine “remaining” value required for 2-page unit views

RemPolitVal=ValPolit−(Polit4Unit*120) i)

RemEconVal=ValEcon−(Econ4Unit*120) ii)

RemCultVal=ValCult−(Cult4Unit*120) iii)

i) Find number of 2-page units for each view

i) Determine Political 2-page units

PolitUnRd2Unit=RemValPolit/100 (1)

Polit2Unit−PolitUnRd2Unit (rounded to 0 decimals) (2)

Polit2Diff=Polit2Unit−PolitUnRd2Unit (3)

ii) Determine Economic 2-page units

EconUnRd2Unit=RemValEcon/100 (1)

Econ2Unit−EconUnRd2Unit (rounded to 0 decimals) (2)

Econ2Diff=Econ2Unit−EconUnRd2Unit (3)

iii) Determine Cultural 2-page units

CultUnRd2Unit=RemValCult/100 (1)

Cult2Unit−CultUnRd2Unit (rounded to 0 decimals) (2)

Cult2Diff=Cult2Unit−CultUnRd2Unit (3)

iv) Determine current selected 2 units

Tot2Unit=Polit2Unit+Econ2Unit+Cult2Unit (1)

v) If Tot2Unit>Num2Unit

(1) Subtract 1 unit from view with lowest value difference

(2) If tie, use lowest view preference

(3) If new Tot2Unit still>Num2Unit

(a) Subtract 1 unit from next lowest value difference

(4) Repeat third time if necessary

vi) If Tot2Unit<Num2Unit

(1) Add 1 unit from view with highest value difference

(2) If tie, use highest view preference

(3) If new Tot2Unit<Num2Unit

(a) Add 1 unit from next lowest value difference

(4) Repeat third time if necessary

vii) Set “actual” fields to targets to track changes in “edit” mode

ActPolit2Unit=Polit2Unit (1)

ActEcon2Unit=Econ2Unit (2)

ActCult2Unit=Cult2Unit (3)

viii) Set Decrement fields to targets

Polit2UnitDec=Polit2Unit (1)

Econ2UnitDec=Econ2Unit (2)

Cult2UnitDec=Cult2Unit (3)

j) Determine which view for which unit

i) First unit and last unit should go to greatest preference and should be longest length possible (i.e., 4-pagers, if available in selection matrix)

(1) Reduce available view/page matrix with selections.

(2) If 9^{th} grade—both units should be 9^{th} grade

(3) If 10^{th} grade—first unit should be 9^{th} grade, last unit should be 12^{th} grade

(4) If 11^{th} or 12^{th} grade, both units should be 12^{th} grade

(5) As selecting units, add to total number of illustrations required for selected unit

TotIllus=TotIllus+TemplateIllusNo (a)

Decrement from selected View/Page (e.g., Polit4Unit=Polit4Unit−1) (6)

ii) All units in between will be randomly selected to the limit of previously calculated view/page matrix:

(1) Grade levels for remaining units should be allocated as follows:

(a) If 9^{th} grade—all units should be 9^{th} grade

ActGrade9=15 (i)

ActGrade12=0 (ii)

(b) If 10^{th} grade—there should be 9-9^{th} grade units and 4-12^{th} grade Units.

ActGrade9=10 (i)

ActGrade12=5 (ii)

(c) If 11^{th} grade—there should be 8-12^{th} grade units and 5-9^{th} grade units.

ActGrade9=5 (i)

ActGrade12=10 (ii)

(d) If 12^{th} grade—all units should be 12^{th} grade

ActGrade9=0 (i)

ActGrade12=15 (ii)

(e) Randomly select 1 (9^{th} grade) or 2 (12^{th} grade), verify that the grade level is available in matrix. If so, decrement the count and proceed to the view selection. If not, choose the alternate grade.

Sample Grade Matrix

| | 9^{th} | 12^{th} |
|---|---|---|
| Grade | Grade | Page |
| 9^{th} | 15 | 0 |
| 10^{th} | 10 | 5 |
| 11^{th} | 5 | 10 |
| 12^{th} | 0 | 15 |

(2) There are 6 combinations of views and pages, assign a number between 1 and 6 to each view (1=Political/4-page, 2=Political/2-page, 3=Economic/4-page, 4=Economic/2-page, 5=Cultural/4-page, 6=Cultural/2-page). Randomly select a number/view. Verify that the view/page is available in the matrix; if so, decrement the count. If not, try next number in sequence until a view/page combination is found that is available (note need to go from 6 to 1 when incrementing)

(3) As selecting units, add to total, number of illustrations required for selected unit

TotIllus=TotIllus+TemplateIllusNo (a)

(4) Decrement one from View/Page matrix for selection

Sample View/Page Matrix

| | | 2- |
|---|---|---|
| View | 4-Page | Page |
| Political | 4 | 2 |
| Economic | 2 | 2 |
| Cultural | 3 | 2 |

k) Biography and Primary document selection—The biography and primary document selections operate analogously; they both use the user's view preferences to weight the selection. The program will choose which routine to run first based on which type (Biography or Primary) has the most total pages to be selected.

The algorithm starts with the “difference” between the target weighting and the actual weighting from the content selection to “adjust” the teacher's preferences in case there was a misallocation. Using a “percent of total preference” allocation, the desired number of biography or primary document pages are allocated to each view. The “difference” from the first calculation is then used to “adjust” the second selection.

After the total biographies and primary documents for each view are determined, they will be randomly selected up to the limits determined. There will be no more than one biography per unit or one primary document per unit. The biographies and primary documents are spread out among the units so that all units will have at least one biography or primary document before any unit will have both a biography and primary document.

a) If (NumBio+NumPrim)=0, then skip whole section (goto ILLUSTRATIONS)

b) Determine new target including “variance” from content selection.

PolitTar=ValPolit−((Polit4Unit*120)+(Polit2Unit*100)−ValPolit) i)

EconTar=ValEcon−((Econ4Unit*120)+(Econ2Unit*100)−ValEcon) ii)

CultTar=ValCult−(Cult4Unit*120)+(Cult2Unit*100)−ValCult) iii)

iv) Calculate total target

TotTar=PolitTar+EconTar+CultTar (1)

c) Biography Document Selection

i) If NumBio>=NumPrim chose biographies first:

(1) Else go to CHOOSING PRIMARY DOCUMENTS FIRST

(2) Calculate number of bio pages per view

(a) Political Biographies

PolitBioUnRd=NumBio*PolitTar/TotTar (i)

PolitBio=PolitBioUnRd (rounded to 0 decimals) (ii)

PolitBioDiff=PolitBioUnRd−PolitTar (iii)

(b) Economic Biographies

EconBioUnRd=NumBio*EconTar/TotTar (i)

EconBio=EconBioUnRd (rounded to 0 decimals) (ii)

EconBioDiff=EconBioUnRd−EconTar (iii)

(c) Cultural Biographies

CultBioUnRd=NumBio,*CultTar/TotTar (i)

CultBio=CultBioUnRd (rounded to 0 decimals) (ii)

CultBioDiff=CultBioUnRd−CultTar (iii)

(3) Determine current selected Bio units

TotBio=PolitBio+EconBio+CultBio (a)

(4) If TotBio>NumBio

(a) Subtract 1 Bio from view with lowest value difference

(i) If tie, use lowest view preference

PolitBio=PolitBio−1 (ii)

Or, EconBio=EconBio−1 (iii)

Or, CultBio=CultBio−1 (iv)

TotBio=TotBio−1 (v)

(b) If new TotBio still>NumBio

(i) Subtract 1 Bio from view with lowest value difference

1. If tie, use lowest view preference

PolitBio=PolitBio−1 2.

Or, EconBio=EconBio−1 3.

CultBio=CultBio−1 4.

TotBio=TotBio−1 5.

(c) If new TotBio still>NumBio, repeat third time

(5) If TotBio<NumBio

(a) Add 1 Bio to view with highest value difference

(i) If tie, use highest view preference

PolitBio=PolitBio+1 (ii)

Or, EconBio=EconBio+1 (iii)

Or, CultBio=CultBio+1 (iv)

TotBio=TotBio+1 (v)

(b) If new TotBio<NumBio

(i) Add 1 Bio to view with next highest value difference

1. If tie, use highest view preference

PolitBio=PolitBio+1 2.

Or, EconBio=EconBio+1 3.

Or, CultBio=CultBio+1 4.

TotBio=TotBio+1 5.

(c) If new TotBio<NumBio, repeat third time

(6) Determine ending “differences” in bio

PolitBioDiff=PolitBio−PolitBioUnRd (a)

EconBioDiff=EconBio−EconBioUnRd (b)

CultBioDiff=CultBio−CultBioUnRd (c)

(7) Set “Actual” bio fields for edit tracking

ActPolitBio=PolitBio (a)

ActEconBio=EconBio (b)

ActCultBio=CultBio (c)

(8) Go to CHOOSING PRIMARY DOCUMENTS SECOND

ii) CHOOSE BIOGRAPHIES SECOND, if NumBio<NumPrim

(1) Calculate number of bio pages per view

(a) Political Biographies

PolitBioUnRd=NumBio*PolitTar/TotTar+PolitPrimDiff (i)

PolitBio=PolitBioUnRd (rounded to 0 decimals) (ii)

PolitBioDiff=PolitBioUnRd−PolitTar (iii)

(b) Economic Biographies

EconBioUnRd=NumBio*EconTar/TotTar+EconPrimDiff (i)

EconBio=EconBioUnRd (rounded to 0 decimals) (ii)

EconBioDiff=EconBioUnRd−EconTar (iii)

(c) Cultural Biographies

CultBioUnRd=NumBio*CultTar/TotTar+CultPrimDiff (i)

CultBio=CultBioUnRd (rounded to 0 decimals) (ii)

CultBioDiff=CultBioUnRd−CultTar (iii)

(2) Determine current selected Bio units

TotBio=PolitBio+EconBio+CultBio (a)

(3) If TotBio>NumBio (same as Biologic above)

(a) Subtract 1 Bio from view with lowest value difference

(b) If tie, use lowest view preference

(c) If new TotBio>NumBio

(i) Subtract 1 unit from next lowest value difference

(d) Repeat third time if necessary

(4) If TotBio<NumBio

(a) Add 1 Bio to view with highest value difference

(b) If tie, use highest view preference

(c) If new TotBio still<NumBio

(i) Add 1 unit to next highest value difference

(d) Repeat third time if necessary

(5) Set “Actual” bio fields for edit tracking

ActPolitBio=PolitBio (a)

ActEconBio=EconBio (b)

ActCultBio=CultBio (c)

d) Primary document selection

i) If CHOOSING PRIMARY DOCUMENTS FIRST: (i.e., if NumBio<NumPrim)

(1) Calculate number of Primary pages per view

(a) Political Primary

PolitPrimUnRd=NumBio*PolitTar/TotTar (i)

PolitPrim=PolitPrimUnRd (rounded to 0 decimals) (ii)

PolitPrimDiff=PolitPrimUnRd−PolitPrim (iii)

(b) Economic Primary

EconPrimUnRd=NumPrim*EconTar/TotTar (i)

EconPrim=EconPrimUnRd (rounded to 0 decimals) (ii)

EconPrimDiff=EconPrimUnRd−EconPrim (iii)

(c) Cultural Primary

CultPrimUnRd NumPrim*CultTar/TotTar (i)

CultPrim=CultPrimUnrd (rounded to 0 decimals) (ii)

CultPrimDiff=CultPrimUnRd−CultPrim (iii)

(2) Determine current selected Primary documents

TotPrim=PolitPrim+EconPrim+CultPrim (a)

(3) If TotPrim>NumPrim

(a) Subtract 1 Prim from view with lowest value difference

(b) If tie, use lowest view preference

(4) If new TotPrim still>NumPrim

(a) Subtract 1 unit from next lowest value difference

(5) If TotPrim<NumPrim

(a) Add 1 Prim to view with highest value difference

(b) If tie, use highest view preference

(6) If new TotPrim>NumPrim.

(i) Add 1 unit to next highest value difference

(7) Determine ending “differences” in primary documents

PolitPrimDiff=PolitPrim−PolitPrimUnRd (a)

EconPrimDiff=EconPrim−EconPrimUnRd (b)

CultPrimDiff=CultPrim−CultPrimUnRd (c)

(8) Set “Actual” primary fields for edit tracking

ti ActPolitPrim=PolitPrim (a)

ActEconPrim=EconPrim (b)

ActCultPrim=CultPrim (c)

(9) Go to “Choose Biographies Second”

ii) If CHOOSING PRIMARY DOCUMENTS SECOND (NumBio>=NumPrim)

(1) Calculate number of primary pages per view

(2) Political Primary Documents

PolitPrimUnRd=NumPrim*PolitTar/TotTar+PolitBioDiff (a)

PolitPrim=PolitPrimUnRd (rounded to 0 decimals) (b)

PolitPrimDiff=PolitPrimUnRd−PolitPrim. (c)

(3) Economic Primary Documents

EconPrimUnRd=NumPrim*EconTar/TotTar+EconBioDiff (a)

EconBio=EconBioUnrd (rounded to 0 decimals) (b)

EconPrimDiff=EconPrimUnRd−EconPrim (c)

(4) Cultural Primary Documents

CultPrimUnRd=NumPrim*CultTar/TotTar+CultBioDiff (a)

CultPrim=CultPrimUnRd (rounded to 0 decimals) (b)

EconPrimDiff=EconPrimUnRd−EconPrim (c)

(5) Determine current selected Primary

TotPrim=PolitPrim+EconPrim+CultPrim (a)

(6) If TotPrim>NumPrim

(a) Subtract 1 Primary from view with lowest value difference

(b) If tie, use lowest view preference

(c) If new TotPrim>NumPrim

(i) Subtract 1 unit from next lowest value difference

(d) Repeat third time if necessary

(7) If TotPrim<NumPrim

(a) Add 1 Primary to view with highest value difference

(b) If tie, use highest view preference

(c) If new TotPrim<NumPrim

(i) Add 1 unit to next highest value difference

(d) Repeat if necessary

(8) Set “Actual” primary fields for edit tracking

ActPolitPrim=PolitPrim (a)

ActEconPrim=EconPrim (b)

ActCultPrim=CultPrim (c)

e) Allocate Biographies and Primary documents to the various units: First the number of units requiring 0, 1 or 2 selections (i.e., Biography, Primary Document, both or none) will be determined and then the pages will be allocated randomly within above calculated limits. Units with both Biographies and primary documents will be allocated first to insure that no type is consumed too soon.

i) Calculated number of documents per unit

BioPrimUnit=(NumBio+NumPrim)/15 (1)

(2) If BioPrimUnit<1

Then, Num0Unit=15−(NumBio+NumPrim) (a)

Else, Num2Unit=NumBio+NumPrim−15 (b)

Num0Unit=0 (i)

(3) Set decrement variable

PolitBioDec=PolitBio (a)

EconBioDec=EconBio (b)

CultBioDec=CultBio (c)

PolitPrimDec=PolitPrim (d)

EconPrimDec=EconPrim (e)

CultPrimDec=CultPrim (f)

BioDec=NumBio (g)

PrimDec=NumPrim (h)

ii) Allocate double units first (if Num2Unit 0 goto REMAINUNITS):

(1) 2UNIT, For Num2Unit

(a) Randomly select unit number (1 through 15)

(b) Verify that unit has not been assigned (i.e. BkUnitBio and BkUnitPrim are blank for unit selected), if so increment unit number and verify again

(d) Read and count valid biographies for unit

(i) “Valid” means:

1. Not previously selected (check TempBiographies)

2. View available (e.g., PolitBioDec>0)

(ii) Randomly select biography from valid pool

(iii) Decrement selected view

(e.g., PolitBioDec=PolitBioDec−1)

(iv) Decrement Bio counter

(BioDec=BioDec−1)

(v) Update Illustration usage table with IllusID of selected Biography

(d) Read and count valid primary documents for unit (similar “validation” rules)

(i) Randomly select primary document from valid pool

(ii) Decrement selected view

(e.g., PolitPrimDec=PolitPrimDec−1

(iii) Decrement Primary counter

(PrimDec=PrimDec−1)

(e) Return to 2UNIT

iii) If Num2Unit=15, then done with Bio/Primary

iv) REMAINUNITS,

(1) UnitNum=0

(2) NEXT UNIT, until UnitNum=15

UnitNum=UnitNum+1 (a)

(b) If unit has already been allocated (checked saved book data) go to NEXT UNIT

(c) If BioPrimUnit<1

(i) Randomly select from (0 or 1)

(ii) if 0

1. If Num0Unit=0 go to ONE

Else, Num0Unit=Num0Unit−1 2.

a. Go to NEXT UNIT

(iii) Else (if 1) go to ONE

(d) ONE,

(i) Set Random=0

(ii) If BioDec=0, set Random=2

(iii) If PrimDec=0, set Random=1

(iv) If Random=0, Randomly select Biography(=1) or Primary(=2) document

(v) If Random=1

BioDec=BioDec−1 1.

2. Read and count valid biographies for unit.

a. “Valid” means:

i. Not previously selected (check TempBiographies)

ii. View available

(e.g. PolitBioDec>0)

3. Randomly select biography from valid pool

4. Decrement selected view

(e.g., PolitBioDec=PolitBioDec−1

5. Update Illustration usage table with IllusID of selected Biography

6. Go to NEXTUNIT

(vi) Else (if=2) go to PRIMARY

(vii) PRIMARY selection

PrimDec=PrimDec−1 1.

2. Read and count valid primary documents for unit (similar “validation” rules)

3. Randomly select primary document from valid pool

4. Decrement selected view

(e.g., PolitPrimDec=PolitPrimDec−1 1.

6. Go to NEXTUNIT

Sample Biography/Primary Matrix

| | | Primary |
|---|---|---|
| View | Biographies | Documents |
| Political | 6 | 5 |
| Economic | 4 | 4 |
| Cultural | 3 | 3 |

f) Illustrations—All illustrations will be chosen after the biographies and primary documents since the biographies also use illustrations and these take precedence. Illustrations have been allocated to each unit in two ways. Certain illustrations are coded as “Must have” and are allocated to a specific image position for a specific unit/view. These illustrations will be chosen first. Other illustrations have been allocated to a “pool” for each unit and these will be selected and placed randomly throughout.

g) Calculate number and type of illustrations.

i) Calculate total illustration preference

IllusPref=PrefPhoto+PrefMap+PrefChart+PrefCartoon (1)

ii) Calculate number of each type of illustration based on preference weight

IllusPhoto=TotIllus*PrefPhoto/IllusPref (1)

IllusMap=TotIllus*PrefMap/IllusPref (2)

IllusChart=TotIllus*PrefChart/IllusPref (3)

IllusCartoon=TotIllus*PrefCartoon/IlllusPref (4)

IllusPhotoDec=IllusPhoto iii)

IlluMapDec=Illusmap iv)

IllusChartDec=IllusChart v)

IllusCartoonDec=IllusCartoon vi)

Sample Matrix

| Illustration Type | Number |
|---|---|
| Photo | 30 |
| Map | 20 |
| Chart | 15 |
| Political Cartoon | 5 |

h) MUSTHAVE, For Unit=1 through 15

i) Read table for selected unit/view/grade/pages and check “must have” illustrations

(1) Use Template to determine how many illustrations to check

ii) For each “Must have” illustration in unit

(1) Determine if “Must have” is available (i.e., not used—TempIllustrations)

(a) If “must have” is not available (i.e., has been taken by biographies or previous units), then randomly select from the pool for the unit

(b) Read and Count valid illustrations for Unit

(i) Valid is:

1. Not used (in TempIllustrations)

2. Type still available

(e.g., IllusPhotoDec>0)

(c) Randomly select number between 1 and count

(2) Update Illustration Usage table with selected IllusID

(3) Decrement Illustration matrix for type used

iii) Return to MUSTHAVE

i) POOL For Unit=1 through 15

i) For selected unit/view/grade/pages randomly assign illustrations to all spots in template that have not yet been assigned (i.e., by “Must haves”)

(1) Read and Count valid illustrations for Unit

(a) Valid is:

(i) Not used (in TempIllustrations)

(ii) Type still available

(e.g., IllusPhotoDec>0)

(2) Randomly select number between 1 and count.

(3) Update Illustration Usage table with selected IllusID

(4) Decrement Illustration matrix for type used

(5) Repeat tiff all illustration spots are filled (make sure “valid” illustrations are updated after each selection)

ii) Return to POOL for next unit.

j) Set “Actual” Illustration fields for edit tracking

ActIllusPhoto=IllusPhoto i)

ActIllusMap=IllusMap ii)

ActIllusChart=IllusChart iii)

ActIllusCartoon=IllusCartoon iv)

After thus compiling the textbook, complete with illustrations, the system can then display the content and layout of the textbook for review and modification by the user.

i) Give options to see:

(1) Alternate views—same length and grade

(2) Longer version—same view and grade

(3) More/less difficult (i.e., grade)—same view and length

ii) After new content selected, must review illustrations prior to re-display on screen

(1) If going to same number of pages (i.e., 4-page to 4-page or 2-page to 2-page)

(a) Check “Must Haves” of new unit.

(i) Verify that “Must Have” is not used (in TempIllustrations).

1. If not used:

a. Subtract 1 from ActIllusType? eliminated

b. Add 1 to ActIllusType? selected

c. Delete old illustration from TempIllustrations

d. Add new illustration to TempIllustrations

e. Update BookUnit table with selected Illustration ID

2. If “Must have” is already used elsewhere, keep original illustration

(2) If going from 4-page selection to a 2-page selection

(a) For illustrations not used (i.e., #2-4)

(i) Keep illustration ID in BookUnit table

(ii) Eliminate Illustration ID from TempIllustrations

(iii) Subtract 1 from ActIllusType? eliminated

(3) If going from 2-page selection to a 4-page selection

(a) Check “Must Haves” of new unit.

(i) If “Must Have” is in Illustration spot 1

1. Verify that “Must Have” is not used (in TempIllustrations).

2. If not used:

a. Add 1 to ActIllusType? selected

b. Add new illustration to TempIllustrations

c. Update BookUnit table with selected Illustration ID

3. If “Must have” is already used elsewhere, keep original illustration

(ii) If “Must Have” is in Illustration spot 2 through 4

1. Verify that “Must Have” is not used (in TempIllustrations).

2. If not used:

a. Add 1 to ActIllusType? Selected

b. Add new illustration to TempIllustrations

c. Update BookUnit table with selected Illustration ID

3. If “Must have” is already used elsewhere

a. See if an illustration was previously assigned (i.e., not blank in BookUnit)

b. If assigned

i. Verify that it is still available.

ii. Add 1 to ActIllusType? selected

iii. Add new illustration to TempIllustrations

iv. Update BookUnit table with selected Illustration ID

c. If not assigned

i. Read and count associated illustrations that have not been used

ii. Randomly select illustration

iii. Add 1 to ActIllusType? selected

iv. Add new illustration to TempIllustrations

v. Update BookUnit table with selected Illustration ID,

4. For non “Must Have” spots 2 through 4

a. See if an illustration was previously assigned (i.e., not blank in BookUnit)

b. If assigned

i. Verify that it is still available.

ii. Add 1 to ActIllusType? selected

iii. Add new illustration to TempIllustrations

iv. Update BookUnit table with selected Illustration ID

c. If not assigned

i. Read and count associated illustrations that have not been used

ii. Randomly select illustration

iii. Add 1 to ActIllusType? selected

iv. Add new illustration to TempIllustrations

v. Update BookUnit table with selected Illustration ID

iii) Read biographies “valid in” current unit and eliminate “already used” biographies from alternate pool

iv) Display thumbnail bios

v) If alternate bio is chosen:

(1) Subtract 1 from ActView?Bio eliminated

(2) Add 1 to ActView?Bio selected

(3) Delete old biography from TempBiographies

(4) Add new biography to TempBiographies

(5) Delete old biography illustration from TempIllustrations

(6) Add new biography illustration to TempIllustrations

(7) Update BookUnit table with selected bio ID

b) Primary Documents

i) Read primary documents “valid in” current unit and eliminate “already used” primary documents from alternate pool

ii) If alternate primary document is chosen:

(1) Subtract 1 from ActView?Prim eliminated

(2) Add 1 to ActView?Prim selected

(3) Delete old primary document from TempPrimaryDocuments

(4) Add new primary document TempPrimaryDocuments

(5) Update BookUnit table with selected Primary document ID

iii) Display thumbnail description of primary documents c) Illustrations

c) Illustrations

i) Read illustrations “valid in” current unit and eliminate “already used” illustrations from alternate pool

ii) If alternate illustration is chosen:

(1) Subtract 1 from ActIllusType? Eliminated

(2) Add 1 to ActIllusType? Selected

(3) Delete old illustration from TempIllustrations

(4) Add new illustration to TempIllustrations

(5) Update BookUnit table with selected Illustration ID

iii) Display thumbnails

### Reverse Algorithm

In certain embodiments described above, a user can select from among an assortment of prepared textbooks, rather than create a textbook from scratch. The following is an exemplary method for determining characteristics of a prepared book, to permit a user to select a textbook having desired characteristics from a database of prepared textbooks.

1) First count all the selected attributes

a) Number of units

i) Political

(1) 4-Page

(2) 2-Page

ii) Economic

(1) 4-Page

(2) 2-Page

iii) Cultural

(1) 4-Page

(2) 2-Page

b) Grade level of units

i) Number of 9^{th} grade

ii) Number of 12^{th} grade

c) Number of Illustrations

i) Photos

ii) Maps and Charts

iii) Editorial Cartoons

d) Number of Biographies

e) Number of Primary Documents

Then determine the original input fields, as described in the previous example, using the reverse of the above techniques.

1) GradeLevel=

a) 9^{th} grade when # of 9^{th} grade units is between 13 to 15

b) 10^{th} grade when # of 9^{th} grade units is between 8 to 12

c) 11^{th} grade when # of 9^{th} grade units is between 3 to 7

d) 12^{th} grade when # of 9^{th} grade units is between 0 to 2

Number of pages=(# of 2-pages×2)+(# of 4-pages×4)+(# of biographies)+(# of primary documents) 2)

3) Unit Preference—need to determine total “value” to use as denominator of Preference calculations.

TotalValue=(# of 2-pages×100)+(# of 4-pages×120) a)

PrefPolit=((# of 2-pagesPolit×100)+(# of 4-pagespolit×120))/TotalValue b)

PrefEcon=((# of 2-pagesEcon×100)+(# of 4-pagesEcon×120))/TotalValue c)

PrefCult=((# of 2-pagesCult×100)+(# of 4-pagesCult×120))/TotalValue d)

PrefBio=# of Bios/15 4)

PrefPrim=# of PrimDocs/15 5)

6) Illustrations—need total number of illustrations for preference calculations

PrefPhoto=# of Photos/TotalIllus a)

PrefMap=# of Maps/TotalIllus b)

PrefChart=# of Photos/TotalIllus (this is zero for the prototype) c)

PrefCartoon=# of Photos/TotalIllus d)

Then write “Catalog” description based on the above determinations.

{Description—words in { } can or can not appear. When displaying the description on the first pass to the user the first word should be “Your”. When saving the description for the library the first word should say “This” The {and} should appear prior to the last type in the group if there is at least two.

{Your} {This} book will be approximately [Number of pages] pages long, and will {strongly} emphasize a {political, {and} cultural, {and} economic, {and} key-figure} approach to the material, with {political, {and} cultural, {and} economic, {and} key-figure} approaches less represented. {You wanted the {political, {and} cultural, {and} economic, {and} key-figure} approach to be least represented.} Photographs {, {and} maps and charts, {and} editorial cartoons, {and primary documents}} will be the most common form of illustration, with fewer examples of {maps, {and} editorial cartoons, {and} charts, {and} primary documents} {, and very few {maps, {and} editorial cartoons, {and} charts, {and primary documents}}.

| | | |
|---|---|---|
| Biography (Key | Strongly | >=75% |
| Figures) | Less | 20% > ? < 75% |
| | Least | <--20 |
| Political, Economic, | Strongly | >=50% |
| Cultural | If not {Strongly) | Highest preference |
| | | goes in group |
| | Less | 15% > ? < 50% (with |
| | | above exception) |
| | Least | <=15% |
| Maps/Charts, | Common | >=25% |
| Editorial Cartoons | Fewer | 10% > ? < 25% |
| | Very Few | <=10% |
| Primary Documents | Common | >=75% |
| | Fewer | 20% > ? < 75% |
| | Very Few | <=20% |

One of several advantages of the present invention over the prior art is that the methods and system described herein provide modules that can be associated and related to generate a customized textbook.

What has thus been described is are methods and systems that can be implemented on a network such as the internet, wherein a server can access information on a database that includes modularized data files. A single modularized data file can be related to a single topic and can be associated with one or more other modules. A user accessing the server can specify a sequence of modules to generate a customized text. Modules can thereafter be further edited by users for greater customization. Modules can be associated with tags that characterize the modules by subject matter, degree of difficulty, learning scales, or other desired measures. Modules can be presented to a user based on one or more of the tag characteristics.

Although the present invention has been described relative to a specific embodiment thereof, it is not so limited. Obviously many modifications and variations of the present invention can become apparent in light of the above teachings. For example, although the illustrated methods and systems provided a single database, multiple databases can be used for the user account information, textual and/or graphic modules, exam questions related to modules, user preferences, etc. Alternately, a single database having multiple partitions can be used, wherein such partitions can be physical or logical. Tags can be represented using a database, single or doubly linked-list, queue, or any other method for associating data elements.

Many additional changes in the details, materials, steps and arrangement of parts, herein described and illustrated to explain the nature of the invention, can be made by those skilled in the art within the principle and scope of the invention. Accordingly, it will be understood that the invention is not to be limited to the embodiments disclosed herein, can be practiced otherwise than specifically described, and is to be understood from the following claims, that are to be interpreted as broadly as allowed under the law.

What is claimed is:

1. A method for assembling a textbook, comprising
receiving preferences from a user,
presenting at least one module to the user based on the preferences,
receiving module selections from the user, and,
assembling the selected modules into an electronic textbook.

2. A method according to claim 1, further comprising providing an interface to allow the user to edit the assembled modules.

3. A method according to claim 1, further comprising providing an interface to modify the preferences.

4. A method according to claim 1, further comprising providing an interface the layout of the modules.

5. A method according to claim 1, further comprising printing the electronic textbook.

6. A method according to claim 1, further comprising transmitting the electronic textbook to the user.

7. A method according to claim 1, wherein receiving preferences from a user further includes receiving at least one data selected from subject matter, location, age level, difficulty level, text length, number of classes, workload per class, text proportion, illustration proportion, teaching style, aspect emphasis, format, assignment types, location, cost per copy, and total cost.

8. A method according to claim 1, wherein receiving information from the user further includes providing an interface having at least one question.

9. A method according to claim 1, wherein receiving information from the user further includes providing an interface having at least one option selection.

10. A method according to claim 1, further comprising assembling questions based on the selected modules.

11. A method according to claim 1, wherein receiving preferences further comprises receiving preferences over a computer network.

12. A method according to claim 1, wherein presenting at least one module to the user based on the preferences includes presenting the at least one module over a network.

13. A method according to claim 1, wherein presenting at least one module to the user based on the preferences further includes associating the preferences with descriptors associated to the modules.

14. A system for assembling a textbook, comprising
at least one user interface to receive preferences from a user, present at least one module to the user based on the preferences, and receive module selections from the user,
at least one database to store the at modules, and,
at least one processor to access the database, coordinate the operation of the user interface, and assemble the selected modules into an electronic textbook.

15. A system according to claim 14, wherein the at least one user interface further comprises an editing module to allow a user to modify the electronic textbook.

16. A system according to claim 14, wherein the at least one user interface further comprises an interface to modify the preferences.

17. A system according to claim 14, wherein the at least one user interface further comprises a layout editor.

18. A system according to claim 14, further comprising a printer for printing the textbook.

19. A system according to claim 14, wherein preferences include information selected from subject matter, age level, difficulty level, text length, number of classes, workload per class, text proportion, illustration proportion, teaching style, aspect emphasis, format, assignment types, location, cost per copy, and total cost.

20. A system according to claim 14, wherein at least one user interface further includes at least one of check boxes, radio buttons, sliders, and text input boxes.

21. A system according to claim 14, further comprising a question generator based on the module selections.

22. A system according to claim 14, further comprising a network connection between the processor and a client.

23. A method for preparing a textbook, comprising
providing a database having electronic textbooks,
providing a user interface for selecting an electronic textbook from the database,
providing an editorial interface for editing the selected electronic textbook, and
recording the edits to the electronic textbook.

24. A method according to claim 23, further comprising printing the recorded textbook.

25. A method according to claim 23, further comprising storing the edited textbook in the database.

26. A method according to claim 23, further comprising placing an order for at least one of the electronic textbooks.

27. A method according to claim 23, wherein providing the editorial interface includes providing an interface for altering text of the selected textbook.

28. A method according to claim 23, wherein providing the user interface includes
providing an interface for receiving preferences from a user, and,
selecting electronic textbooks from the database that are associated with the preferences.

29. A method according to claim 23, further comprising assembling questions based on the selected textbook.

30. A system for preparing a textbook, comprising
at least one database including electronic textbooks,
at least one user interface for selecting an electronic textbook from the database,
an editorial interface for editing the electronic textbook, and
a processor to access the database and control at least one of the user interface and the editorial interface.

31. A system according to claim 30, further comprising a printer in communication with the processor.

32. A system according to claim 30, wherein the at least one database further includes memory for storing an edited textbook.

33. A system according to claim 30, further comprising a storage system for storing an edited textbook.

34. A system according to claim 30, wherein the electronic textbooks are arranged according to at least one of subject matter, location, age level, and difficulty level.

35. A system according to claim 30, wherein the editorial interface includes a text editor.

36. A system according to claim 30, further comprising an exam generator for assembling questions based on the selected electronic textbook.

37. A system according to claim 41, wherein the processor is coupled to a network.

38. A database comprising a plurality of modules associated with at least one tag being indicative of at least one of subject matter, difficulty, grade level, teaching style, and curricula.

39. A database according to claim 38, wherein the at least one tag can be associated with questions based on the subject matter of the module.

40. A database comprising electronic textbooks sorted according to at least one of subject matter, difficulty, grade level, and geographic location of the creator.

41. A database according to claim 40, further comprising contact information for creators of the textbooks.

42. A database according to claim 40, wherein the contact information further includes electronic mail addresses.

43. A method for presenting a virtual classroom, comprising,
providing a customized textbook,
providing at least one of notes, an exam, and
references associated with the customized textbook.

44. A method according to claim 43, wherein providing a customized textbook further comprises providing the customized textbook over a network.

45. A method according to claim 43, further comprising providing at least one interface for transmitting an answered exam to at least one of a storage device and a network destination.

46. A method according to claim 43, further comprising providing at least one interface for transmitting an answered exam to an email destination.

47. A method for creating a virtual classroom, comprising,
providing a customized textbook, and,
associating electronic resources with the customized textbook, the electronic resources based on the contents of the customized textbook.

48. A method according to claim 47, wherein, providing a customized textbook further comprises selecting modules for inclusion in the textbook, the selected modules being associated with electronic resources.

49. A method according to claim 47, wherein associating electronic resources further comprises associating at least one of a URL, a HTTP link, an image, and a textual document.
